(19) United States
(12) Patent Application Publication
(10) Pub. No.: US 2026/0319928 A1
(43) Pub. Date: Oct. 15, 2026

(54) LARGE LANGUAGE MODEL BASED SOLUTION FOR END TO END TEST CASE GENERATOR IN A CLOUD ENVIRONMENT

(71) Applicant: Dell Products L.P., Round Rock, TX (US)

(72) Inventor: Walmikee Sanjay Dhopte, Maharashtra (IN)

(21) Appl. No.: 19/175,850

(22) Filed: Apr. 10, 2025

(51) Int. Cl. G06F 11/3668; G06F 16/334

(52) U.S. Cl. CPC G06F 11/3688; G06F 11/3684; G06F 11/3696; G06F 16/3347

(57) ABSTRACT

A method for managing a computing environment includes obtaining a user query for generating a test case for a computing product in the computing environment, in response to the user query: applying a vectorized embedding on the user query based on a test description of the user query to obtain a vectorized user query, applying a retrieval augmented generation (RAG) mechanism on the user query using vectorized documents and based on the test description to obtain a subset of the vectorized documents, applying the vectorized user query and the subset of vectorized documents to a large language model (LLM) to obtain the test case, wherein the test case comprises a set of steps for testing the computing product, and issuing a response to the client device that comprises the test case, wherein the test case is applied to the computing production the computing environment.

### BACKGROUND

Computing products such as software may undergo testing prior to deployment or prior to providing the products to the public. Generating and implementing the tests on the computing products may require many hours before the computing products are ready for deployment. Generating high quality tests may improve the efficiency of the testing process.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a flowchart of a method for generating vectorized documents in accordance with one or more embodiments of the invention.

FIG. 3 shows a flowchart of a method for servicing user queries in accordance with one or more embodiments of the invention.

FIG. 4 shows an example in accordance with one or more embodiments of the invention.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this disclosure, elements of figures may be labeled as A to N, A to P, A to M, or A to L. As used herein, the aforementioned labeling means that the element may include any number of items, and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments of the invention include systems and methods for utilizing large language models (LLMs) to generate steps for testing computing products (e.g., software). Specifically, embodiments of the invention may utilize a retrieval augmented generation (RAG) mechanism to generate vectorized documents and use the vectorized documents to enhance the LLMs when obtaining queries for generating test steps for the computing products.

In one or more embodiments, the RAG mechanism refers to a framework that includes using existing datasets (e.g., documents, files, etc.) to service user queries. The existing datasets may be vectorized and embedded with additional information such as, for example, semantics to generate vectorized documents. Each user query may be processed in accordance with the RAG approach to identify one or more relevant vectorized documents that may be used to generate a response to the user query. The user query may be processed with the identified relevant subset of the vectorized documents using a LLM to generate the response.

Embodiments of the invention include using a data system that includes functionality for obtaining user queries and generating the test steps. The data system may include a data store that stores product information such as existing computing products and previous test cases. The RAG approach may be applied to the information stored in the data store (in addition to any new data obtained later) for servicing the user queries.

Various embodiments of the invention are described below.

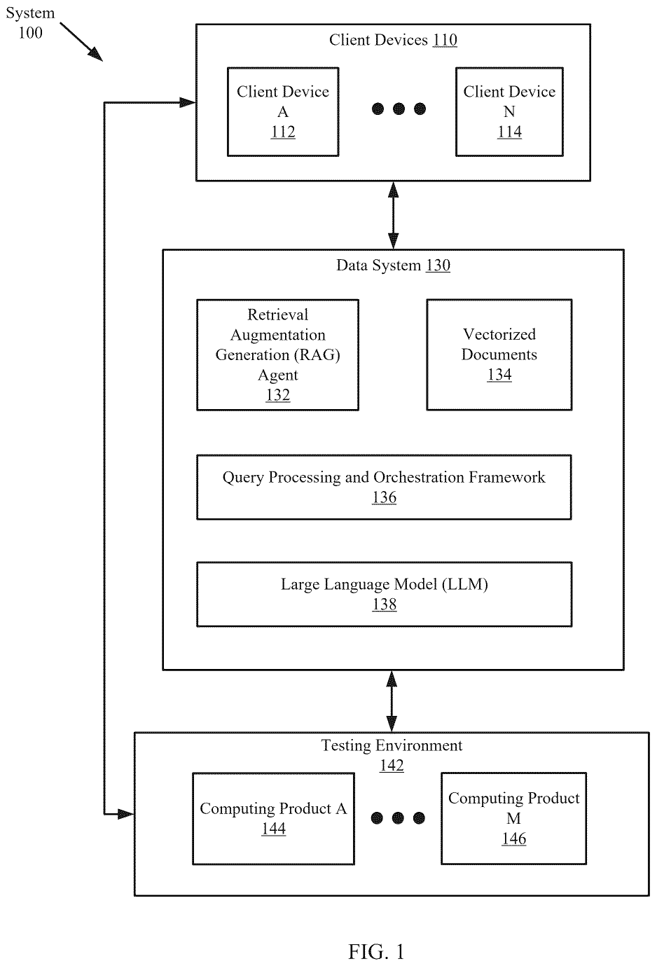

FIG. 1 shows a system in accordance with one or more embodiments of the invention, The system (100) includes any number of client devices (110), a data system (130), and a testing environment (142). The overall system (100) may include additional, fewer, and/or different components without departing from the scope of the invention. Each component may be operably connected to any of the other component via any combination of wired and/or wireless connections. Each component illustrated in FIG. 1 is discussed below.

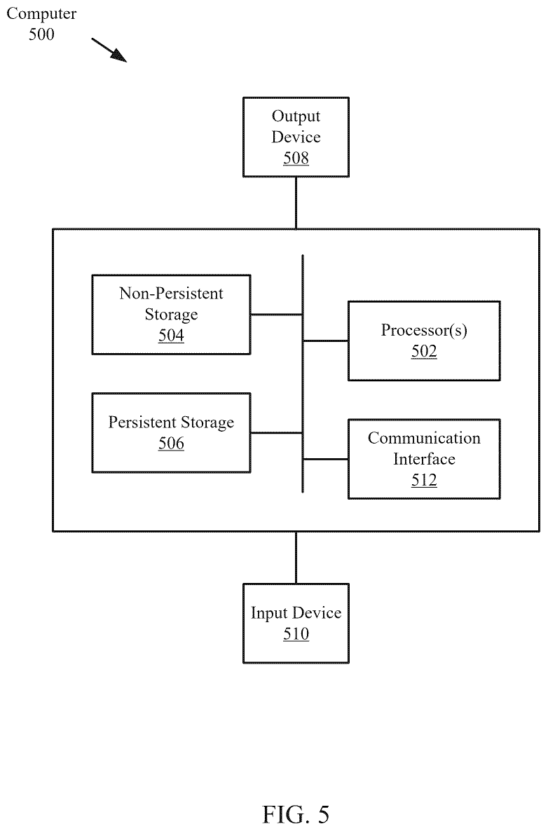

In one or more embodiments, each client device (112, 114) is implemented as one or more computing devices (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the client device (112, 114) described throughout this present disclosure.

In one or more embodiments of the invention, each client device (112, 114) is implemented as a logical device. A logical device may utilize the computing resources of any number of computing devices (refer to FIG. 5) to provide the functionality of the client environment (112, 114) described throughout this present disclosure.

In one or more embodiments, each client device (112, 114) may be used by any number of users managing data online using the data system (130). The users may access the data via computing devices of the respective client device (112, 114). Further, any of the users may be, for example, developers that manage the development and/or deployment of one or more computing products (144, 146). Specifically, the users, operating using one or more client devices (112, 114), may create the one or more computing products (144, 146) and perform tests to evaluate the operability of the one or more computing products (144, 146). The testing may include applying one or more test steps on the computing product and recording the results.

Examples of types or portions of testing applied on a computing product may include, for example, functional testing the user interface, security testing, continuous evaluation of performance metrics of one or more portions of the computing product, unit integration testing, regression testing based on previous tests performed, end-to-end (E2E) testing to evaluate flow of operations for the entire computing product, and exploratory testing to evaluate potential defects for marginal use cases. The testing or test cases discussed throughout the present disclosure may refer to the aforementioned examples or other types or portions of testing without departing from the invention. In one or more embodiments, the test cases applied to the computing products (144,146) may each be described using a set of test steps and an order of the test steps for implementing the test case.

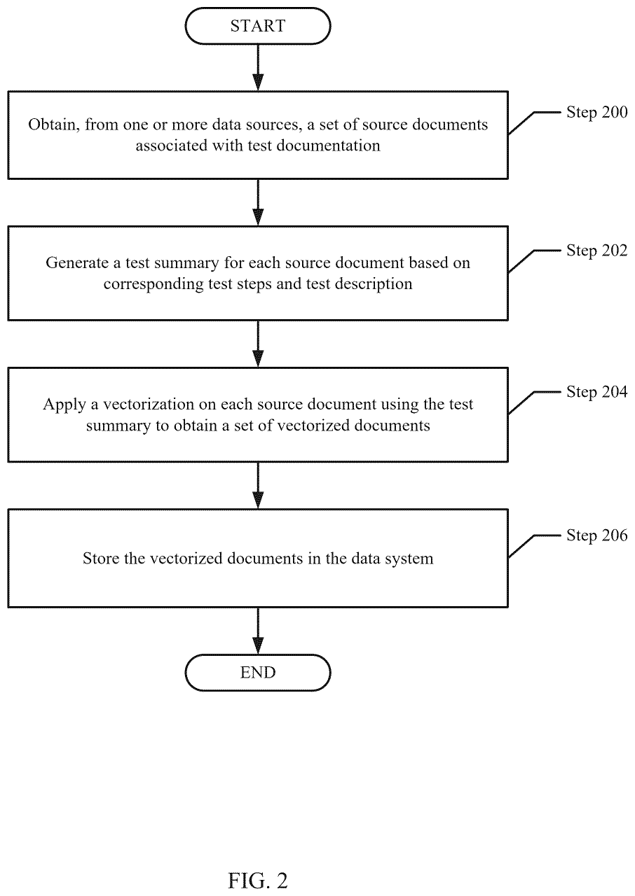

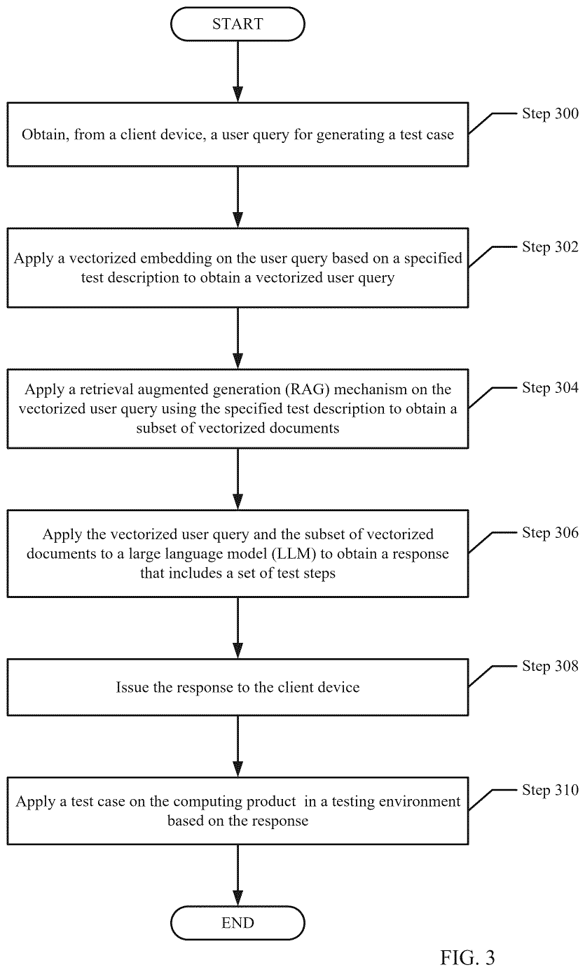

The set of steps may be determined, for example, using the data system (130) in accordance with the methods of FIGS. 2-3. Other methods may be used to determine test steps for test cases without departing from the invention. In one or more embodiments, a client device (112, 114) may issue user queries to the data system (130). A user query may refer to a question, initiated by a user of the client devices (110), that requests the generation and/or implementation of the test steps. The data system (130) may perform the methods of FIGS. 2-3 to service such user queries.

In one or more embodiments, the data system (130) provides the functionality for: (i) obtaining user queries for data in the data sources (142) in a natural language, (ii) processing the user query using a large language model (LLM), and (iii) providing a response in the natural language. To perform the aforementioned functionality, the data system (130) includes a retrieval augmentation generation (RAG) agent (132), the large language model (LLM) (138), a query processing and orchestration framework (136), and one or more vectorized documents (134). The data system (130) may include additional, fewer, and/or different components without departing from the invention.

In one or more embodiments, the query processing and orchestration framework (136) includes functionality for obtaining user queries from the client devices (110) and servicing the user queries in accordance with the method of FIG. 3. Specifically, the query processing and orchestration framework (136) includes functionality for processing queries by performing decomposition of each user query, retrieving multiple queries (also referred to as sub-queries) from each user query based on the decomposition, and servicing the user queries using the RAG mechanism and the LLM (138).

In one or more embodiments, the vectorized documents (138) are a collection of chunked and processed portions of source documents obtained from the client devices (112, 114). Each vectorized document may be associated with a source document and embedded with additional metadata such as concepts, intent, emotion, and/or other additional information that is used during semantic and/or keyword search by an ensemble retrieval that implements similarity measures such as semantic search and keyword search applied to the vectorized documents (138). An example sematic search may include Facebook artificial intelligence (AI) similarity search (FAISS). An example keyword search is best match 25 (BM25). The vectorized documents (134) may further be collectively referred to as a vectorized database. Each source document may include, for example, a description of a test case (also referred to as a test description) and corresponding test steps for implementing the test case.

In one or more embodiments, the RAG agent (132) includes functionality for generating the vectorized documents (134) in accordance with FIG. 2 and for applying a RAG mechanism to identify a subset of vectorized documents to be used for servicing each user query. For additional details regarding the RAG mechanism, refer to FIG. 3.

In one or more embodiments, the LLM (138) is a machine learning model that obtains inputs that include: (i) user queries written in a natural language and (ii) one or more of the vectorized documents (134) collected as an enhanced context of a corresponding user query. The LLM (138) may output a response to the user query, using the content of the inputted one or more vectorized documents (138). The output may be in a natural language. The LLM (138) may be implemented using any machine learning algorithm (e.g., convolutional neural network (CNN), generative artificial intelligence (AI), etc.) without departing from the invention.

In one or more embodiments, the data system (130) (and/or each component illustrated within) is implemented as a computing device (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the data system (130) (and/or each component illustrated within) described throughout this present disclosure including the methods of FIGS. 2-3.

Alternatively, in one or more embodiments of the invention, the data system (130) (and/or each component illustrated within) is implemented as a logical device. A logical device may utilize the computing resources of any number of computing devices to provide the functionality of the data system (130) (and/or each component illustrated within) described throughout this present disclosure including the methods of FIGS. 2-3.

In one or more embodiments, the testing environment (142) is a computing environment that includes any number of computing devices (e.g., 500, FIG. 5) that provide computing services. The computing services may include the execution of test cases as discussed throughout the present disclosure. The test cases may be applied to one or more computing products (144, 146) executing in the testing environment (142).

In one or more embodiments, each computing product (144, 146) is implemented as a logical device. A logical device may utilize the computing resources of any number or any portion of computing devices (refer to FIG. 5) to provide the functionality of the computing product (144, 146) described throughout this present disclosure. Examples of computing products include, but are not limited to: virtual machines, application containers, software products, databases, user interfaces, and/or a multi-module computing entity.

While the system (100) of FIG. 1 shows one testing environment (142) executing the computing products (144, 146), any number of testing environments may be included in the system (100) without departing from the invention.

FIG. 2 shows a flowchart of a method for generating vectorized documents in accordance with one or more embodiments of the invention. The method shown in FIG. 2 may be performed by, for example, a data system (130, FIG. 1). Other components of the system illustrated in FIG. 1 may perform the method of FIG. 2 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 200, a set of source documents are obtained from one or more data sources. In one or more embodiments, the source documents may be associated with test documentation. Each source document may include a test description for a test case applied to one of the computing products (144, 146, FIG. 1) and corresponding test steps for performing the test case. Each source document may further include computing product information such as an identifier of the computing product, information of the units or modules performed on the computing product, and/or other information associated with the computing product being tested via a test case.

In step 202, a test summary is generated for each source document based on corresponding test steps and test descriptions. In one or more embodiments, the test summary may be generated using, for example, a large language model (LLM), or other artificial intelligence (AI) mechanism for summarizing natural language descriptions of the test. The test summary may summarize the test steps in a natural language. The test summary generated for each source document may be a shorter description than the test steps and/or the test description.

In step 204, a vectorization is applied on each source document using the test summary to obtain a set of vectorized documents. In one or more embodiments, the vectorization includes embedding each source chunk with metadata, or other information, that may be used for semantic search while servicing a user query in accordance with FIG. 3. The metadata may include, for example, the corresponding test summary, keywords corresponding to the type of test applied, and semantic words used for semantic search.

In step 206, the vectorized documents are stored in the data system.

FIG. 3 shows a flowchart of a method for servicing user queries in accordance with one or more embodiments of the invention. The method shown in FIG. 3 may be performed by, for example, a data system (130, FIG. 1). Other components of the system illustrated in FIG. 1 may perform the method of FIG. 3 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to FIG. 3, in step 300, a user query is obtained from a client device. The user query may include a request to generate a test case (including a set of test steps) for testing a computing product. The user query may be in a natural language. The user query may specify a test description for a test to be performed. The user query may further provide computing product information of the computing product to be tested.

In step 302, a vectorized embedding is applied on the user query to obtain a vectorized user query. In one or more embodiments, the vectorized embedding includes generating the vectors using the subset of vectorized documents to generate the vectorized user query. The vectorized embedding includes identifying semantic tokens associated with the test description and/or the user query and embedding the user query with the identified semantic words.

In step 304, a retrieval augmented generation (RAG) mechanism is applied on the vectorized user query using the specified test description to obtain a subset of vectorized documents. In one or more embodiments, the RAG mechanism is a process for searching the vectorized database to identify the most relevant subset of vectorized documents for enhancing the test step generation requested by the user query. Identifying the most relevant subset may be based on searching the vectorized database using semantic tokens of the vectorized user query and comparing the tokens, or other keywords of the vectorized user query, to semantic tokens and/or other keywords of the vectorized database. Additionally, an ensemble retriever may be used that implements any combination of two or more similarity measures such as semantic search (e.g., FAISS) and keyword search (e.g., BM25). Based on the comparison and the corresponding ensemble retriever, the subset of vectorized documents are identified based on which documents shared a predefined threshold of keywords and/or semantic tokens. The vectorized user query may be further embedded with the identified subset.

In step 306, the vectorized user query and the subset of vectorized documents are applied to a LLM to obtain a response. In one or more embodiments, the LLM may be prompted, or otherwise configured, to a predefined format such as a set of steps, identifying a set of subqueries (each corresponding to a vectorized document) of the user query based on a decomposition of the user query to obtain the subqueries, filtering the subset of vectorized documents to identify a set of relevant steps for providing the test case. Additional parameters of the format for the response may include, for example, preventing the inclusion of unnecessary information not present in the context of the test case, incorporating commands as part of the test steps, and the format including a series of steps to execute. In one or more embodiments, the decomposition of the user query to obtain the subqueries includes identifying the subqueries in the user query, inputting each of the subqueries (with the subset of vectorized documents) to the LLM with the predefined format, prompting the LLM to provide a response in a user readable format. The LLM may output a response in accordance with the predefined format. The response may include a test case that includes the test steps for efficiently executing the requested test description.

In one or more embodiments, to avoid hallucinations of the LLM, the generated response is compared to at least one existing test case in the subset of vectorized documents to evaluate the accuracy of the response. For example, the generated response may include a test case for testing a computing product specified in the user query. The test case may be evaluated using the existing test case(s) of the subset of vectorized documents to confirm and/or otherwise modify the generated test case based on the steps generated in the response. For example, for any generated test steps deemed to not be based on any of the compared steps in the existing test case(s), the data system may modify such test steps to prevent hallucinations or other inaccurate steps.

In step 308, the response is issued to the client device.

In step 310, based on the response, the test case is applied to the computing product in a testing environment. In one or more embodiments, the data system may be initiated to execute the generated test steps of the response. For example, the client device may initiate the testing to be performed by the data system on the computing product. The data system, in response to the initiation, may execute the test steps generated in step 306 on the computing product to test the operability, or other aspect, of the computing product. Executing the steps may produce results that may be provided to the client device.

In one or more embodiments, following the servicing of any number of user queries, the vectorized database may implement continuous machine learning (CML) by continuing to update the vectorized documents (e.g., the method of FIG. 2) based on continuous implementations of test cases and/or based on updated test cases applied to the computing products. In this manner, the method of FIG. 3 may be performed using data aggregation of updated vectorized documents and/or other updated test cases.

### Example

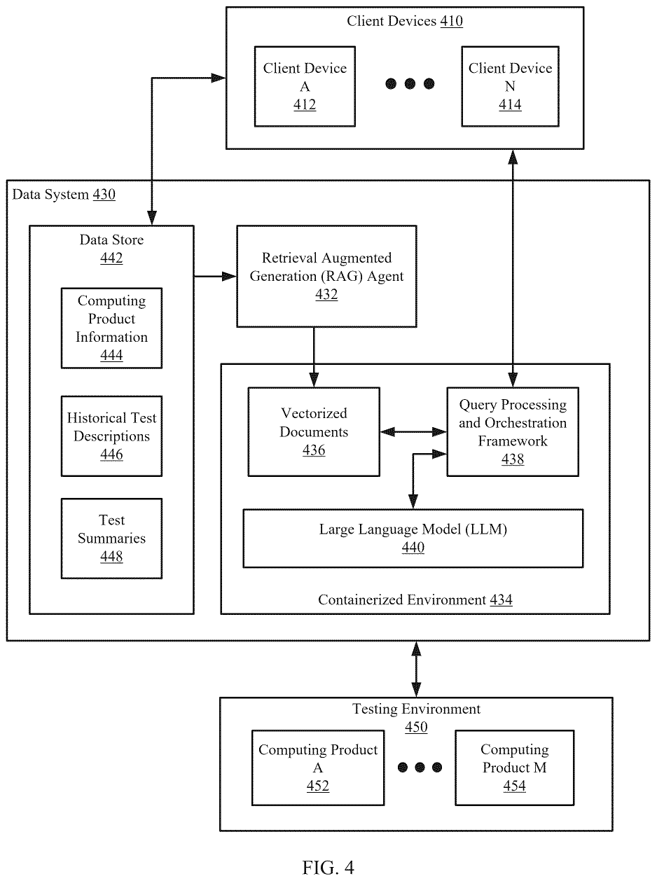

To clarify aspects of the invention, an example system is illustrated in FIG. 4. The example system is not intended to limit the scope of the invention. Turning to the example system, consider a scenario in which a computing environment hosts any number of undeployed software being tested prior to deployment. A set of developers may perform tests on the computing products. However, developing the test cases to be applied may require a significant level of knowledge and understanding of the computing products and of existing test cases. Additionally, the development may require several hundred hours of time taken creating the test steps and evaluating the results for additional testing. A data system may be utilized to reduce the number of hours required for useful testing and further reduce the cognitive burden applied to the developers to determine the test cases.

Turning to FIG. 4, the example system includes any number of client devices (410) each operated by a developer performing the testing. Any one or more of the client devices (412, 414) may store computing product information (444) and historical test descriptions (446) in a data store (442) of the data system (430). The computing product information (444) includes any required information to understand the operations or any other capabilities of the computing products (452, 454).

The data system (430) may further include a RAG agent (432) that obtains the computing product information (444) and the historical test descriptions (446) to generate the test summaries (448) and the vectorized documents (436) in accordance with the corresponding methods of FIGS. 2-3. Further, the data system (430) includes a containerized environment (434) that enables interaction with the developers via the client devices (410) by obtaining user queries and servicing them in accordance with FIG. 3. The containerized environment (434) may execute in a cloud environment accessible to the client devices (412, 414). Specifically, one or more of the client devices (412, 414) include interfaces that enable the client devices (412, 414) to communicate with a query processing and orchestration framework (438) that obtains user queries for generating the test cases based on a given test description. The query processing and orchestration framework (438), in response to receiving the user queries, performs the RAG mechanism on the vectorized documents as discussed throughout the present disclosure to select a subset of vectorized documents relevant to generating test steps.

The identified subset is embedded in the user query to obtain a vectorized user query that includes additional relevant information such as historical test descriptions that are deemed similar or otherwise relevant to the requested test description of the user query. The vectorized user query is applied to the LLM (440) of the containerized environment (434) to obtain a response. Prior to inputting the vectorized user query, the LLM (440) may be pre-programmed to format the responses to include a series of steps for executing a test case on a computing product (452, 454), identifying subqueries, and incorporating the subqueries to generate the test steps. The subqueries each represent one of the subset of vectorized documents deemed relevant to the test case generation.

### End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computer (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention improve the processing of natural language queries by improving natural language processing to SQL (or other database formats) translations to democratize access to complex data systems within organizations. Such access may enable non-technical staff to interact with databases more easily. This could lead to new insights and better decision-making at all levels of the organization.

Embodiments of the invention may improve the efficiency of processing user queries to manage a computing environment. Specifically, embodiments of the invention improve the process of testing computing products in the computing environment and managing the lifecycle of a computing product from development to deployment. Embodiments of the invention provide computer-aided analysis of the testing of to increase the efficiency of computing product development by reducing cognitive burden on developers providing testing operations. As such, the computing environments hosting computing products developed using the more efficient development are also improved, thus improving the user experience.

Thus, embodiments of the invention may address the problem of inefficient use of computing resources. This problem arises due to the technological nature of the environment in which computing products are developed.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing a computing environment, the method comprising:
obtaining, by a data system and from a client device, a user query for generating a test case for a computing product in the computing environment;
in response to the user query:
applying a vectorized embedding on the user query based on a test description of the user query to obtain a vectorized user query;
applying a retrieval augmented generation (RAG) mechanism on the user query using vectorized documents and based on the test description to obtain a subset of the vectorized documents;
applying the vectorized user query and the subset of vectorized documents to a large language model (LLM) to obtain the test case, wherein the test case comprises a set of steps for testing the computing product; and
issuing a response to the client device that comprises the test case, wherein the test case is applied to the computing production the computing environment.

2. The method of claim 1, further comprising:
prior to obtaining the user query:
obtaining source documents associated with a plurality of computing products comprising at least the computing product,
wherein at least one source document of the source documents comprises:
a second test description for testing one of the plurality of computing products and
test steps associated with the test description;
generating, for the at least one source document, a test summary based on the test description and the test steps; and
applying the vectorization on the at least one source document to generate a first vectorized document of the vectorized documents,
wherein the vectorization comprises embedding the source document with the test summary and with additional semantic parameters associated with the test description, the test steps, and the test summary.

3. The method of claim 2, wherein the RAG mechanism comprises:
performing a semantic search on the first vectorized document to determine that the at least one source document is relevant to the test case; and
based on the semantic search, updating the subset of vectorized documents with the first vectorized document.

4. The method of claim 2, further comprising:
after performing the test case:
obtaining a second source document associated with testing a second computing product of the plurality of computing products,
wherein the second source document comprises:
a second test description for testing the second computing product and second test steps associated with the second test description;
generating, for the second source document, a second test summary based on the second test description and the second test steps; and
applying the vectorization on the second source document based on the second test description, the second test steps, and the second test summary to generate a second vectorized document; and
updating the vectorized documents with the second vectorized document to obtain updated vectorized documents,
wherein the updated vectorized documents are used for user queries associated with generating future test cases.

5. The method of claim 1, further comprising:
prior to applying the vectorized user query and the subset of vectorized documents to the LLM, performing a structuring on the LLM to format the response to include a series of steps.

6. The method of claim 1, wherein performing the test case comprises:
applying the set of steps to the computing product;
obtaining results associated with the set of steps; and
storing the results as a source document.

7. The method of claim 1, wherein the user query is written in a natural language.

8. A non-transitory computer readable medium comprising computer readable program code, which when executed by a computer processor enables the computer processor to perform a method for managing a computing environment, the method comprising:
obtaining, by a data system and from a client device, a user query for generating a test case for a computing product in the computing environment;
in response to the user query:
applying a vectorized embedding on the user query based on a test description of the user query to obtain a vectorized user query;
applying a retrieval augmented generation (RAG) mechanism on the user query using vectorized documents and based on the test description to obtain a subset of the vectorized documents;
applying the vectorized user query and the subset of vectorized documents to a large language model (LLM) to obtain the test case, wherein the test case comprises a set of steps for testing the computing product; and
issuing a response to the client device that comprises the test case, wherein the test case is applied to the computing production the computing environment.

9. The non-transitory computer readable medium of claim 8, further comprising:
prior to obtaining the user query:
obtaining source documents associated with a plurality of computing products comprising at least the computing product,
wherein at least one source document of the source documents comprises:
a second test description for testing one of the plurality of computing products and
test steps associated with the test description;
generating, for the at least one source document, a test summary based on the test description and the test steps; and
applying the vectorization on the at least one source document to generate a first vectorized document of the vectorized documents,
wherein the vectorization comprises embedding the source document with the test summary and with additional semantic parameters associated with the test description, the test steps, and the test summary.

10. The non-transitory computer readable medium of claim 9, wherein the RAG mechanism comprises:
performing a semantic search on the first vectorized document to determine that the at least one source document is relevant to the test case; and
based on the semantic search, updating the subset of vectorized documents with the first vectorized document.

11. The non-transitory computer readable medium of claim 9, further comprising:
after performing the test case:
obtaining a second source document associated with testing a second computing product of the plurality of computing products,
wherein the second source document comprises:
a second test description for testing the second computing product and second test steps associated with the second test description;
generating, for the second source document, a second test summary based on the second test description and the second test steps; and
applying the vectorization on the second source document based on the second test description, the second test steps, and the second test summary to generate a second vectorized document; and
updating the vectorized documents with the second vectorized document to obtain updated vectorized documents,
wherein the updated vectorized documents are used for user queries associated with generating future test cases.

12. The non-transitory computer readable medium of claim 8, further comprising:
prior to applying the vectorized user query and the subset of vectorized documents to the LLM, performing a structuring on the LLM to format the response to include a series of steps.

13. The non-transitory computer readable medium of claim 8, wherein performing the test case comprises:
applying the set of steps to the computing product;
obtaining results associated with the set of steps; and
storing the results as a source document.

14. The non-transitory computer readable medium of claim 8, wherein the user query is written in a natural language.

15. A system, comprising:
a data system operating on a processor; and
memory comprising instructions, which when executed by the processor, perform a method comprising:
obtaining, from a client device, a user query for generating a test case for a computing product in a computing environment, wherein the user query is written in a natural language;
in response to the user query:
applying a vectorized embedding on the user query based on a test description of the user query to obtain a vectorized user query;
applying a retrieval augmented generation (RAG) mechanism on the user query using vectorized documents and based on the test description to obtain a subset of the vectorized documents;
applying the vectorized user query and the subset of vectorized documents to a large language model (LLM) to obtain the test case, wherein the test case comprises a set of steps for testing the computing product; and
issuing a response to the client device that comprises the test case, wherein the test case is applied to the computing production the computing environment.

16. The system of claim 15, further comprising:
prior to obtaining the user query:
obtaining source documents associated with a plurality of computing products comprising at least the computing product,
wherein at least one source document of the source documents comprises:
a second test description for testing one of the plurality of computing products and
test steps associated with the test description;
generating, for the at least one source document, a test summary based on the test description and the test steps; and
applying the vectorization on the at least one source document to generate a first vectorized document of the vectorized documents,
wherein the vectorization comprises embedding the source document with the test summary and with additional semantic parameters associated with the test description, the test steps, and the test summary.

17. The system of claim 16, wherein the RAG mechanism comprises:
performing a semantic search on the first vectorized document to determine that the at least one source document is relevant to the test case; and
based on the semantic search, updating the subset of vectorized documents with the first vectorized document.

18. The system of claim 16, further comprising:
after performing the test case:
obtaining a second source document associated with testing a second computing product of the plurality of computing products,
wherein the second source document comprises:
a second test description for testing the second computing product and second test steps associated with the second test description;
generating, for the second source document, a second test summary based on the second test description and the second test steps; and
applying the vectorization on the second source document based on the second test description, the second test steps, and the second test summary to generate a second vectorized document; and
updating the vectorized documents with the second vectorized document to obtain updated vectorized documents,
wherein the updated vectorized documents are used for user queries associated with generating future test cases.

19. The system of claim 15, further comprising:
prior to applying the vectorized user query and the subset of vectorized documents to the LLM, performing a structuring on the LLM to format the response to include a series of steps.

20. The system of claim 15, wherein performing the test case comprises:
applying the set of steps to the computing product;
obtaining results associated with the set of steps; and
storing the results as a source document.
